(19) United States
(12) Patent Application Publication
(10) Pub. No.: US 2023/0141738 A1
(43) Pub. Date: May 11, 2023

(54) LATENCY REDUCTION WITH ORTHOGONAL FREQUENCY DIVISION MULTIPLE ACCESS (OFDMA) AND A MULTIPLE RESOURCE UNIT (MRU)

(71) Applicant: MAXLINEAR, INC., Carlsbad, CA (US)

(72) Inventor: Sigurd Schelstraete, Menlo Park, CA (US)

(21) Appl. No.: 18/052,934

(22) Filed: Nov. 6, 2022

Related U.S. Application Data
(60) Provisional application No. 63/263,632, filed on Nov. 5, 2021.

(51) Int. Cl. H04L 5/00

(52) U.S. Cl. CPC H04L 5/0064; H04L 5/0007; H04L 5/0035

(57) ABSTRACT

Systems and methods for reducing latency using an orthogonal frequency division multiple access (OFDMA) transmission include allocating an asymmetrical amount of frequency in at least one resource unit (RUs) and a multiple RU (MRU), with a portion of the frequency being reserved for latency sensitive data.

### CROSS REFERENCE TO RELATED APPLICATIONS

This U.S. patent application claims priority to U.S. Provisional Patent Application 63/263,632 filed on Nov. 5, 2021. The disclosure of this prior application is considered part of the disclosure of this application and is hereby incorporated by reference in its entirety.

### TECHNICAL FIELD

The embodiments discussed in the present disclosure are related to latency reduction with orthogonal frequency division multiple access (OFDMA) and a multiple resource unit (MRU).

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Data transmitted over the network may experience delays and/or latency as the number of devices included in the network increase, the amount of data transmitted over the network increases, and/or combinations of an increased number of devices and data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One aspect of the disclosure provides a method for reducing latency in a wireless network. The method includes obtaining data to be transmitted. The data may include latency sensitive data and non-latency sensitive data. Within an available bandwidth, the method may include allocating a portion of the available bandwidth to a resource unit (RU). The RU may be for the latency sensitive data within an orthogonal frequency division multiple access (OFDMA) transmission. The OFDMA transmission may also include a multiple RU (MRU) for the latency sensitive data. The RU may be a different size than the MRU.

In another example, an access point may include one or more processors and a memory coupled to the one or more processors. The one or more processors may be configured to execute instructions to cause the access point to perform operations that may include identify a plurality of users to receive an orthogonal frequency division multiple access (OFDMA) transmission and for the OFDMA transmission, allocate an uneven distribution of available bandwidth among the plurality of users to receive the OFDMA transmission, with a portion of the frequency being reserved for latency sensitive data.

In a further example, a non-transitory computer readable storage medium may be configured to store instructions that, when executed by a processor included in a computing device, cause the computing device to perform operations that, for an OFDMA transmission, may include to allocate an asymmetrical amount of frequency among a plurality of users to receive the OFDMA transmission, with a portion of the frequency being reserved for latency sensitive data.

### BRIEF DESCRIPTION OF THE DRAWINGS

Example embodiments will be described and explained with additional specificity and detail through the use of the accompanying drawings in which:

FIG. 1 illustrates a block diagram of an example system including an access point (AP), a network, and one or more stations (STAs);

FIG. 2 illustrates example multiple resource units (MRUs) used in conjunction with OFDMA transmissions to unequally share bandwidth or spectrum among two users;

FIG. 3 illustrates example used in conjunction with OFDMA transmissions to unequally share bandwidth or spectrum among multiple users;

FIG. 4 illustrates an example scheduling system that may be used for OFDMA packet distribution within a network;

FIG. 5 illustrates flowchart of an example arrangement of operations for a method for latency reduction using OFDMA and an MRU; and

FIG. 6 is a schematic view illustrating a machine in the example form of a computing device within which a set of instructions, for causing the machine to perform any one or more of the methods discussed herein, may be executed.

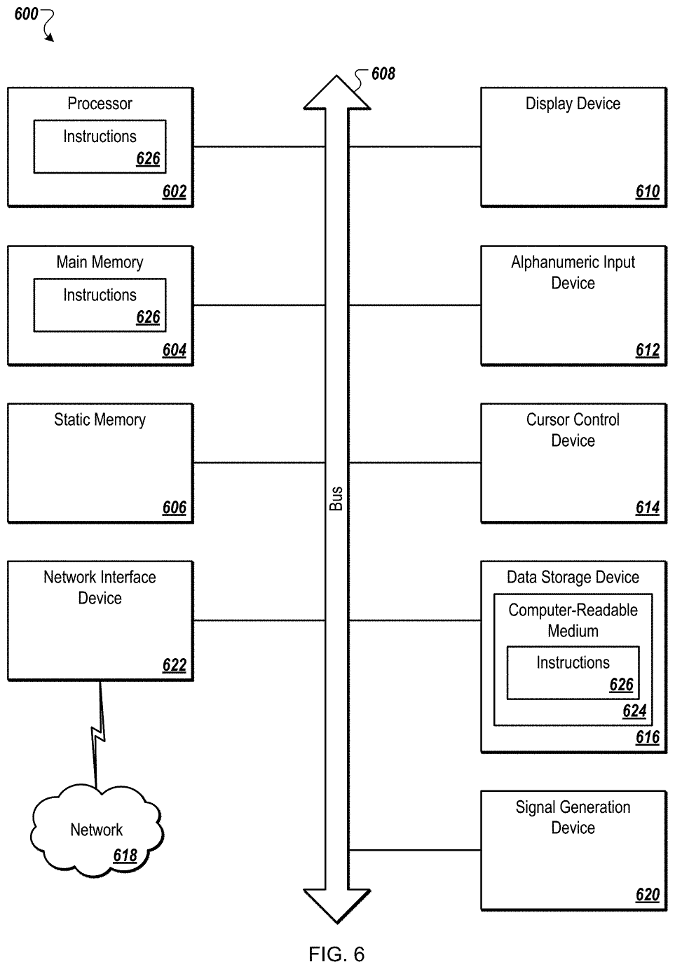

### DETAILED DESCRIPTION

Wireless communications, such as those implementing the IEEE 802.11 protocol, may benefit from data transmission improvements such increased throughput and/or improved latency. IEEE 802.11be may include improvements such as extremely high throughput and/or improved worst case latency and jitter, when compared to prior IEEE 802.11 protocols. In some circumstances, IEEE 802.11be and Wi-Fi 7 may be used to describe the same protocol and may be used interchangeably.

In some circumstances, attempts to improve latency in wireless communications may include implementing restricted target wake time (rTWT). rTWT may include a reservation type service for wireless communications that may provide reserved service periods for a latency sensitive frame to be transmitted. In some instances, a frame may refer to a packet. The latency sensitive data may include any data or other information that may be time sensitive in transmission or reception (e.g., a system heartbeat, data used in subsequent decisions, video streaming, etc.). A latency sensitive service may include any service that has a timing element such that an increased latency may adversely affect the service or the operation thereof. In some circumstances, the implementation of rTWT may be optional such that one or more devices in a network may not assign service periods for latency sensitive frames. Alternatively, or additionally, in instances in which service periods are assigned for latency sensitive frames, some frames transmitted by one or more devices in a network may infringe the service periods for the latency sensitive frames.

Further, some prior approaches include data delivery using a scheduling system that may assign a schedule for a device to communicate over a network. For example, the network may be configured to implement round-robin scheduling, where each device in the network may be allocated a transmission window. In some embodiments, the frames to be transmitted from any device may be limited to an allocated transmission window, which may be without regard to frame length and/or to latency sensitive data. For example, a first device may be allocated a first transmission window, a second device may be allocated a second transmission window, and so forth. The first device may include non-latency sensitive data having and the second device may include a latency sensitive data. In the example, the latency sensitive data may be scheduled to follow the non-latency sensitive data due to the scheduling, which may result in higher than desired latency for the latency sensitive data.

Further, as the number of devices increase, the duration of time between scheduled transmissions of a device may increase, which may cause additional delays in transmitting latency sensitive data. Alternatively, or additionally, delays may increase with an increased load on the network, which may include more devices and/or more traffic between the devices (e.g., more and/or longer frames being transmitted). To help alleviate traffic congestion in multi-user networks, orthogonal frequency division multiple access (OFDMA) has been used, but in prior approaches, resource allocation in OFDMA was limited in flexibility. For example, under prior approaches, 160 MHz can only be split between two users evenly using equally sized resource units (RU)—80/80 MHz, which can result in unused bandwidth if one or both of the users does not need all 80 MHz.

Aspects of the present disclosure address these and other shortcomings with prior approaches by reducing latency using an OFDMA transmission to include allocating an asymmetrical amount of frequency, such as a larger amount of frequency to a multiple RU (MRU) and a smaller amount of frequency to a RU and then assigning latency sensitive data or a latency sensitive service to either the MRU or to the RU. In some instances, the latency sensitive data or service is assigned to the RU because of the RU's smaller amount of frequency, which may have less of an impact on overall bandwidth. For example, the present disclosure provides resource allocations that are asymmetrical between users. Continuing the above example, the 160 MHz can be split as 20 MHz and 140 MHz between two users, rather than evenly as under prior approaches. OFDMA may permit efficient transmissions of small frames to a group of users simultaneously. In OFDMA transmissions, the whole bandwidth may be divided into multiple subsets of subcarriers, each subset being an RU. Each RU may be assigned to or associated with a user or a user group which is typically referred to as user scheduling.

Further, use of MRUs in combination with OFDMA can be used to improve the latency of a particular service over one or more transmissions. For example, when a latency sensitive service is present, the present disclosure provides techniques to semi-permanently reserve part of the bandwidth for this service, such as by reserving 20 MHz for this service, such as with an RU, and permitting other traffic to use an MRU for the remaining bandwidth (e.g., the 140 MHZ in the 160 MHz example). This may have the effect of creating a low-latency channel with the RU, which allows each of the non-latency sensitive users to transmit OFDMA packets with the latency sensitive user as the second user. In this manner, the latency sensitive user can effectively bypass a round robin scheduling system. Moreover, in the event that the bandwidth reserved for latency sensitive data/services is not used, because of the relatively small size of the reserved RU, the overall bandwidth may be minimally impacted.

In some embodiments, an OFDMA transmission, such as a physical layer (PHY) protocol data unit (PPDU), may use one or more MRUs to share bandwidth between non-latency sensitive traffic and latency sensitive traffic. Also with OFDMA, an RU may be used with an MRU to divide the bandwidth of the OFDMA transmission unevenly. In instances in which the OFDMA transmission is divided into an MRU and an RU, non-latency sensitive traffic and latency sensitive traffic may be transmitted simultaneously to multiple users in the same OFDMA transmission.

Further, the part of the bandwidth not expressly reserved for the latency sensitive service may also be used for that latency sensitive service. In this manner, every OFDMA transmission regardless of destination may carry latency sensitive traffic in part of the bandwidth, using OFDMA and one or more MRUs, as further described herein.

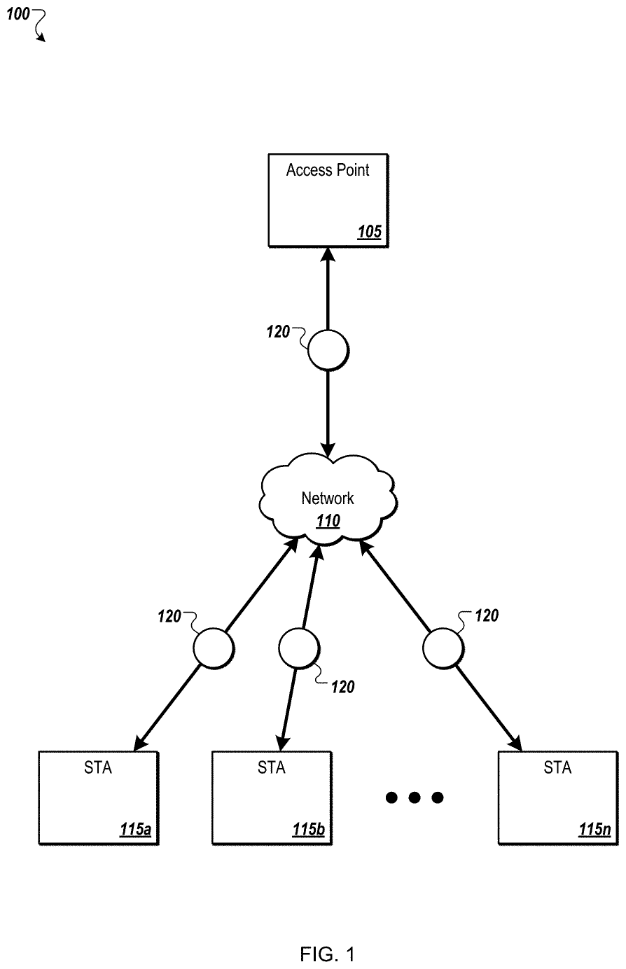

FIG. 1 illustrates a block diagram of an example system 100 including an access point (AP) 105, a network 110, and one or more stations (STA) 115a-n. The AP 105 and STAs 115a-n may be configured for orthogonal frequency division multiple access (OFDMA) communication. Both the AP 105 and the STAs may be capable to transmit and/or receive OFDMA data. Most data transmission standards specify or require radio frequency bands to use for communications. For example, some of the more common radio frequency bands that are used for Wi-Fi communications include 900 MHz, 2.4 GHz, 3.6 GHz, 4.9 GHz, 5 GHz, 5.9 GHz, 6 GHz and 60 GHz. Each range is divided into multiple channels. The most common channel widths are 20 MHz, 40 MHz, 80 MHz, and 160 MHz, although any channel width may be used including 240 MHz, 320 MHz, 640 MHz, 1280 MHz, 2560 MHz, etc.

Channels may be defined within the available bandwidth, including by defining multiple channels of equal width, or of non-equal width. Channels may be contiguous or non-contiguous, with any combination of width variations, such as 320/160+80+40+20+20 MHz, 240/160+40+20+20 MHz, 160/80+40+20+20, 80/40+20+20, or any other combination (where the number to the left of the “/” is the total available bandwidth and the numbers to the right of the “/” are various channel widths, where the channels are separated by “+”. Example bandwidth types to create the various combinations may include 20 MHz, 40 MHz, 80 MHz, 160 MHz, and 320 MHz, etc. Further, less than all available bandwidth may be associated with a channel, for example, as in a 320/160+20 configuration (with a 160 MHz RU and a 20 MHz RU), a 160/80+20 (80 MHz RU and 20 MHz RU) configuration, etc. In some instances, one or more channels may be bonded together to create wider channels for higher throughput. The system 100 may provide support for any contiguous or non-contiguous channel width.

Each channel includes multiple subcarriers, which may also be referred to as tones. Data subcarriers within the channels may be modulated using binary phase shift keying (BPSK), quadrature phase shift keying (QPSK), 16-quadrature amplitude modulation (16-QAM), 64-QAM, 256-QAM, 512-QAM, 1024-QAM, 4096-QAM, or greater. Forward error correction (FEC) coding (such as convolutional or Low Density Parity Check (LDPC) coding) may be used with coding rates of 1/2, 2/3, 3/4 and 5/6.

With OFDMA, the AP 105 may divide the spectrum or available bandwidth into MRUs and RUs of various sizes. The size of an RU can vary from very small (e.g., 26 subcarriers or 2 MHz) to very large, (e.g., 996 tones (or 77.8 MHz) or more). The RUs can be allocated to one user or to more than one user.

Different numbers and sizes of MRUs and RUs can be allocated for transmissions to different users, based on how much data each STA 115a-n needs or whether the data is latency sensitive. The AP 105 is responsible for MRU and RU assignment, coordination, and scheduling. For example, applications that use a lot of data, such as streaming video, can be assigned a large RU (or an MRU), while applications that require very little data can be assigned a small RU. In another example, applications with latency sensitive data, such as streaming video, can be assigned a somewhat smaller RU but over more than one OFDMA transmission to reduce overall latency for the latency sensitive data. Each RU and MRU can use a different modulation scheme, coding rate and level, and RU/MRU assignments can vary on a frame by frame basis.

For scheduling, the AP 105 may include a scheduler that may be used for uplink and downlink OFDMA. Uplink OFDMA allows data frames to be transmitted simultaneously by multiple STAs 115a-n. Using uplink OFDMA may amortize preamble overhead and medium contention overhead, which may increase aggregated network throughput. Uplink OFDMA can provide additional gains by permitting greater transmit power level per STA 115a-n, and thus signal coverage on the uplink, since the transmit power of each STA 115a-n can be concentrated on smaller allocated RUs. Further, for uplink OFDMA, the AP 105 may allocate an RU within the available spectrum to be used for latency sensitive data so that one of the STAs 115a-n can avoid contention for the latency sensitive data.

Downlink OFDMA allows multiple data frames to be transmitted in a OFMDA transmission (e.g., a PPDU) single data unit to multiple STAs 115a-n, thus amortizing preamble overhead and medium contention overhead, leading to higher aggregated network throughput. Downlink OFDMA can further optimize aggregate throughput by balancing the allocation of power between users at high versus low signal-to-noise ratios, subject to total power constraints. The scheduler of the AP 105 may ultimately determine how to combine data frames from the STAs 115a-n into a single OFDMA transmission (either downlink or uplink) and can allocate an RU for latency sensitive data for downlink OFDMA.

The AP 105 may also define a MRU by combining multiple RUs. An MRU may include combinations of multiple RUs of any of 26-tone, 52-tone, 106-tone, 242-tone, 484-tone, 996-tone, 2×996-tone, or 4×996-tone RUs. RUs of any size may be combined, and small size RUs (e.g., under 242-tone RUs) may be combined with large size RUs (e.g., equal to or larger than 242-tone RUs). In a more specific example, a small-size RU (e.g., 26-tones) may be used for OFDMA and for latency sensitive services and/or users and may be combined with one or more large size MRUs (e.g., one or more 996-tone), thus using more available spectrum to be used for most of the data while also enabling latency sensitive data to move through the network 110 in a relatively fast manner. The larger size MRUs may be used for both non-latency sensitive services and latency sensitive services.

In a more specific example of using a combination of RUs and without using an MRU, spectrum allocations for RUs may have different combinations of tones. For example—if there are three STAs associated with the AP 105, as illustrated by STA 115a-n, then the AP can assign 26-tone RU to a first STA 115a (e.g., for latency sensitive data), and 106-tone RUs each to the other two STAs 115b, n. These RU allocations decisions are dynamically made by the AP and may be based on the STA traffic type and availability to receive a particular transmission. The AP 105 may also use this technique of assigning RUs to each OFDMA transmission as a mechanism to create a dedicated latency sensitive channel for uplink and/or for downlink. Latency sensitive RUs can be used for various types of data or services, where timing is important, such as in real-time voice and video applications.

Modifications, additions, or omissions may be made to the system 100 without departing from the scope of the present disclosure. For example, any number of STAs 115a-n may be used. Other modifications, additions, or omissions may be made to the system 100 without departing from the scope of the present disclosure. For example, in some embodiments, the system 100 may include any number of other components that may not be explicitly illustrated or described.

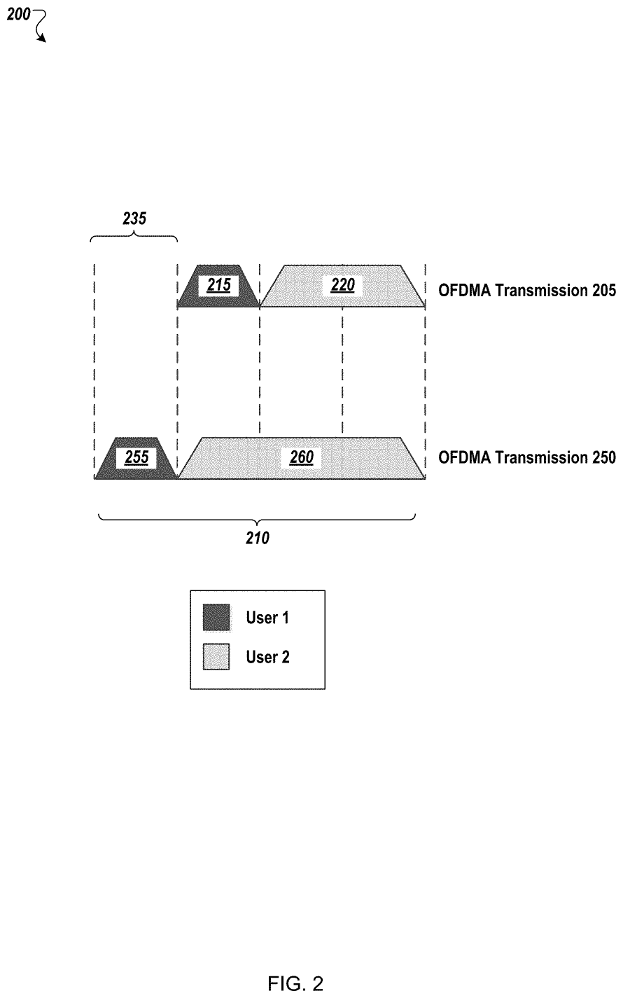

FIG. 2 illustrates example OFDMA transmissions 205, 250 to unequally share bandwidth or spectrum 210 among two users using MRUs 220, 260 and RUs 215, 255. As illustrated, OFDMA transmission 205 includes an RU 215 for a first user (e.g., user 1). The RU 215 may be used or reserved for latency sensitive data. The OFDMA transmission 205 may also include an MRU 220 that may be used for non-latency sensitive data and may be associated with a second user (e.g., user 2). The MRU 220 may also be used for latency sensitive data. The OFDMA transmission 205 uses most of the available spectrum 210 with any amount of the spectrum punctured 235. Also, while the MRUs 220, 260 and RUs 215, 255 are illustrated within the spectrum 210 at a particular position, the MRUs 220, 260 and RUs 215, 255 may be allocated anywhere within the available spectrum 210 to form the OFDMA transmission 205.

The OFDMA transmission 250 is similar to the OFDMA transmission 205 but the OFDMA transmission 250 is a full-bandwidth transmission without punctured spectrum. FIG. 2 is not drawn to scale and while the RU 215 and RU 225 appear the same size, they may be the same size or a different size. Similarly, while the MRU 220 and MRU 260 appear a different size, they may be the same size or a different size. The RU 255 and MRU 260 may be allocated anywhere within the available spectrum 210 to form the OFDMA transmission 250.

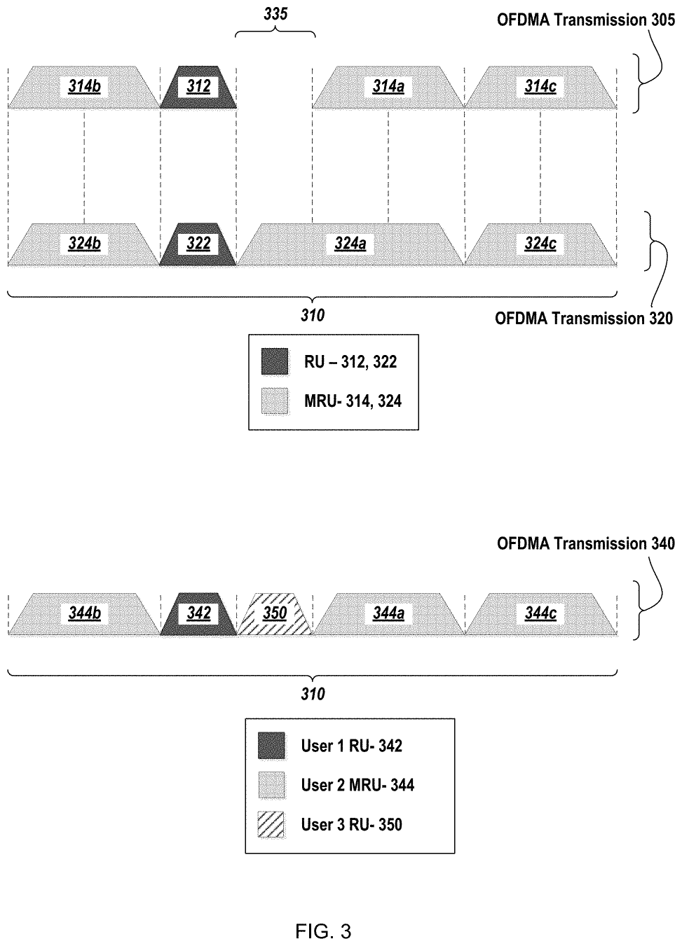

FIG. 3 illustrates example OFDMA transmissions 305, 320 used in conjunction with OFDMA transmissions to unequally share bandwidth or spectrum 310 among multiple users.

As illustrated, OFDMA transmission 305 includes RU 312 and MRU 314. The RU 312 may be any size (e.g., any number of tones—26, 52, 106, 242, 484, 996, etc.) and may be smaller in size than the MRU 314. As illustrated, the MRU 314 includes multiple RUs 314a, 314b, 314c of any size that together form the MRU 314. The RU 312 may be used or reserved for latency sensitive data. The OFDMA transmission 305 may also include any number of RUs or MRUs that may be used for non-latency sensitive data and may be associated with one or more other users. For example, the RU 312 may be associated with a first user (e.g., user 1) and the MRU 314 may be associated with a second user (e.g., user 2).

As illustrated, the OFDMA transmission 305 uses most of the available spectrum 310 with any amount of the spectrum punctured 335. Also, while the RUs 312, 314a, 314b, 314c are illustrated within the spectrum 310 at a particular position, the RUs 312, 314a, 314b, 314c may be allocated anywhere within the available spectrum 310 to form the MRU 314.

The OFDMA transmission 320 is similar to the OFDMA transmission 305 but the OFDMA transmission 320 is a full-bandwidth transmission without punctured spectrum. The OFDMA transmission 320 includes an RU 322 for latency sensitive data/service and an MRU 324 that includes three RUs 324a, 324b, 324c of any size.

The OFDMA transmission 340 is similar to the OFDMA transmission 305 but the OFDMA transmission 340 includes another user (user 3). As illustrated, the OFDMA transmission 340 includes a first user RU 342, a second user MRU 344, and a third user RU 350. The RUs 342, 350, the MRU 344, and the RUs that make up the MRU (344a, 344b, 344c) may be any size. In some embodiments, the RU 342 is used or reserved for latency sensitive data, and the MRU 344 and RU 350 are not expressly reserved for latency sensitive data. While three users are illustrated, OFDMA transmissions with an MRU may also include RUs for any number of users.

FIG. 3 is not drawn to scale and while some of the RUs and/or MRUs may appear the same size, the RUs and/or MRUs may be any size, including the same size or a different size.

In some embodiments, spectrum assignment for subsequent transmissions may change. For example, an AP (such as AP 105 of FIG. 1) may assign or allocate a first group of spectrum for a latency sensitive service or for latency sensitive data. Over time, that first group of spectrum, or tones, may provide less than ideal conditions for the latency sensitive service or for latency sensitive data. Those less than ideal conditions may be cause by anything, including due to interference, or may not have an easily identifiable root cause. In some instances, a feedback system may be used to measure latency among any of the spectrum or any portion of the spectrum to identify a particular group of spectrum that may provide latency that is below a latency threshold, and may be done in an effort to reduce latency for certain latency sensitive data. A current latency of the latency sensitive service or for latency sensitive data may be measured and compared to latency for other groups of spectrum. For any reason, including to improve latency, the AP may use different groups of spectrum for different OFDMA transmissions to further reduce overall latency for the latency sensitive service or for latency sensitive data

Modifications, additions, or omissions may be made to the aspects of FIGS. 2-3 without departing from the scope of the present disclosure. For example, any number of RUs and MRUs, of any size, may be used. Any number of users may be used. Other modifications, additions, or omissions may be made to the aspects of FIGS. 2-3 without departing from the scope of the present disclosure.

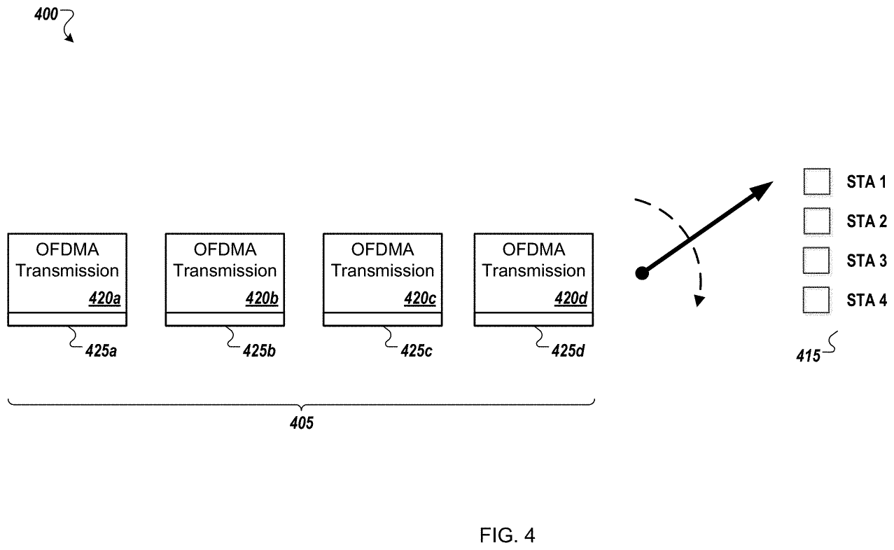

FIG. 4 illustrates an example scheduling system 400 that may be used for OFDMA packet distribution within a network. As illustrated, system 400 includes a data stream 405 of OFDMA transmissions 420. The OFDMA transmissions 420 may be transmitted to, from, and among the STAs 415 following the round-robin scheduling where non-latency sensitive traffic may be scheduled (e.g., sequentially), and latency sensitive traffic 425 may be scheduled to be transferred in each OFDMA transmission 420.

In some embodiments, the network may include OFDMA in conjunction with an MRU which may be configured to divide frames over the transmitting bandwidth. In some embodiments, a combination of OFDMA and MRU may support the bandwidth of a frame to be divided into unequal portions (e.g., an unequal bandwidth distribution). For example, a 160 MHz bandwidth may be divided into an MRU and an RU—an MRU for a 140 MHz portion and a RU for a 20 MHz portion. In some embodiments, the uneven bandwidth distribution may be arranged such that a majority of the frame may be configured for non-latency sensitive traffic and a minority of the frame may be configured for latency sensitive traffic.

Each OFDMA transmission 420 may include a portion that is reserved for latency sensitive traffic 425. In some instances, a portion of the spectrum is reserved for latency sensitive traffic and if a particular packet has more latency sensitive traffic than can fit in the reserved portion, the latency sensitive traffic can also be transmitted in an RU that is not part of the spectrum reserved for the latency sensitive traffic.

In some embodiments, the AP may allocate/assign an RU based on an amount of spectrum needed for the latency sensitive traffic and the remainder of the spectrum may be used for the latency sensitive traffic, such that each frame is substantially fully occupied (subject to puncturing).

In instances in which the frames in a network include uneven bandwidth distribution using an MRU, the non-latency sensitive traffic may be scheduled in a round-robin schedule and a portion of the frame bandwidth may be reserved in an RU for latency sensitive traffic. In some embodiments, the arrangement of the uneven bandwidth distribution may improve efficiency and throughput in a network and/or may improve worst case latency for latency sensitive traffic as bandwidth for the latency sensitive traffic may be reserved in each frame in the network. For example, in instances in which a device includes latency sensitive traffic, but a number of other devices are scheduled to transmit prior to the device, the latency sensitive traffic may be transmitted in the portion of bandwidth reserved for latency sensitive traffic.

In some embodiments, a scheduler of system 400 may identify multiple users or STAs 415 to receive an OFDMA transmission 425. The scheduler for the OFDMA transmission may allocate an uneven distribution of available bandwidth among the users or STAs 415 to receive the OFDMA transmission 420, with a portion of the frequency being reserved for latency sensitive data 425. When allocating the uneven distribution of available bandwidth among the users to receive the OFDMA transmission 420, the scheduler may allocate the uneven distribution of available bandwidth among the users or STAs 415 for multiple OFDMA transmissions 420a-d, such as by allocating an RU to be used by each OFDMA transmissions 420a-d for the latency sensitive data 425.

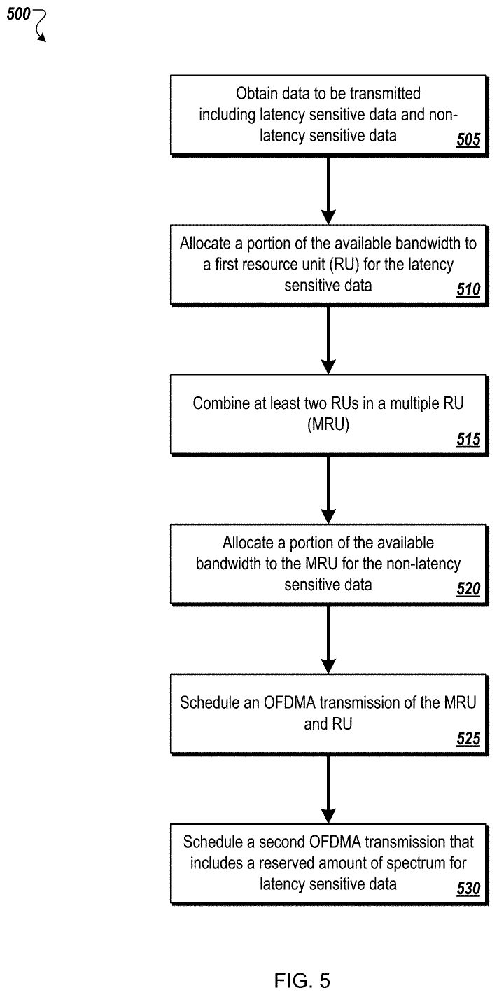

FIG. 5 illustrates flowchart of an example arrangement of operations for a method 500 for latency reduction using OFDMA and an MRU. The methods may be performed by processing logic that may include hardware (circuitry, dedicated logic, etc.), software (such as is run on computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

Referring to FIG. 5, a method 500, at operation 505, includes obtaining data to be transmitted including latency sensitive data and non-latency sensitive data. The data to be transmitted may include a physical layer (PHY) protocol data unit (PPDU), a high throughput (HT) PPDU (HT-PPDU), a very high throughput (VHT) PPDU (VHT-PPDU), or an extremely high throughput (EHT) PPDU (EHT-PPDU).

The method 500, at operation 510, includes allocating, within an available bandwidth, a portion of the available bandwidth to a first resource unit (RU) for the latency sensitive data. The first RU may be for the latency sensitive data. Allocating the portion of the available bandwidth to the first RU may include allocating the portion of the available bandwidth for multiple sequential data packets to be transmitted. The available bandwidth may be 160 megahertz (MHz) or greater.

The method 500, at operation 515, includes combining at least two RUs in a multiple RU (MRU). The MRU may be for the non-latency sensitive data, for the latency sensitive data, or both. The first RU may be a different size than the MRU. The first RU for the latency sensitive data may be smaller than the MRU.

The method 500, at operation 520, includes allocating a portion of the available bandwidth to the MRU for the non-latency sensitive data, for the latency sensitive data, or both. . The latency sensitive data may be associated with a first entity. The first RU may be associated with the first entity, and the MRU may be associated with a second entity. The first entity may be either a user or a service. In some embodiments, the MRU may include a specific RU to carry at least a portion of the latency sensitive data and at least a portion of the non-latency sensitive data.

The method 500, at operation 525, includes scheduling an OFDMA transmission of the MRU and the RU. The OFDMA transmission may span the entire available bandwidth.

The method 500, at operation 530, includes scheduling transmission of a second OFDMA transmission that includes a reserved amount of spectrum for latency sensitive data. Scheduling transmission of the second OFDMA transmission may include defining the second OFDMA transmission to include an RU for latency sensitive data associated with the first entity, and a MRU for a third entity;

FIG. 5 is a schematic view illustrating a machine in the example form of a computing device 600 within which a set of instructions, for causing the machine to perform any one or more of the methods discussed herein, may be executed. The computing device 600 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one implementation, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 626 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In an example, a multi-link device may include a memory and one or more processors operatively coupled to the memory. The one or more processors may be configured to execute operations including to obtain data to be transmitted, the data including latency sensitive data and non-latency sensitive data, assign at least a portion of the latency sensitive data to a first channel, and assign non-latency sensitive data to a second channel, the first channel having a smaller width than the second channel. The example multi-link device may include a first link and a second link, where the first channel is associated with the first link of the multi-link device, where the second channel is associated with the second link of the multi-link device. The example multi-link device may be configured to operate in a 320 MHz or greater system. The example multi-link device may include first channel being assigned based on an interference measurement related to the first channel.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining data to be transmitted, the data including latency sensitive data and non-latency sensitive data; and
within an available bandwidth, allocating a portion of the available bandwidth to a resource unit (RU), the RU being for the latency sensitive data within an orthogonal frequency division multiple access (OFDMA) transmission, the OFDMA transmission also including a multiple RU (MRU) for non-latency sensitive data, the RU being a different size than the MRU.

2. The method of claim 1, the MRU including a mix of non-latency sensitive data and latency sensitive data.

3. The method of claim 1, wherein the data to be transmitted includes a physical layer (PHY) protocol data unit (PPDU), or an extremely high throughput (EHT) PPDU (EHT-PPDU).

4. The method of claim 1, wherein the OFDMA transmission spans an entire available bandwidth.

5. The method of claim 1, wherein allocating the portion of the available bandwidth to the RU includes allocating the portion of the available bandwidth for a plurality of sequential data packets to be transmitted.

6. The method of claim 1, the latency sensitive data being associated with a first entity, the RU being associated with the first entity, and the MRU being associated with a second entity.

7. The method of claim 6, the first entity being either a user or a service.

8. The method of claim 6 further comprising:
defining a second OFDMA transmission including:
a second RU for latency sensitive data associated with the first entity, and
a second MRU for a third entity; and
transmitting the second OFDMA transmission.

9. The method of claim 1, the MRU comprising a third RU to carry at least a portion of the latency sensitive data and at least a portion of the non-latency sensitive data.

10. The method of claim 1, the RU for the for the latency sensitive data having fewer than 242 tones, the MRU having at least one RU equal to or larger than 242-tones.

11. The method of claim 1, the available bandwidth being 160 megahertz (MHz) or greater.

12. An access point, comprising:
one or more processors; and
a memory coupled to the one or more processors, the one or more processors being configured to execute instructions to cause the access point to perform operations comprising:
identify a plurality of users to receive an orthogonal frequency division multiple access (OFDMA) transmission; and
for the OFDMA transmission, allocate an uneven distribution of available bandwidth among the plurality of users to receive the OFDMA transmission, with a portion of the frequency being reserved for latency sensitive data.

13. The access point of claim 12 further comprising a transmitter coupled to the one or more processors, the transmitter to transmit the OFDMA transmission to the plurality of users.

14. The access point of claim 12, wherein when allocating the uneven distribution of available bandwidth among the plurality of users to receive the OFDMA transmission, the access point is to allocate the uneven distribution of available bandwidth among the plurality of users for a plurality of OFDMA transmissions.

15. The access point of claim 14, wherein the plurality of users includes an intended recipient of the latency sensitive data, wherein each OFDMA transmission of the plurality of OFDMA transmissions includes a resource unit (RU) that is reserved for the latency sensitive data.

16. The access point of claim 12, wherein the OFDMA transmission includes a first resource unit (RU) and a second RU that collectively comprise a multiple RU (MRU), wherein the OFDMA transmission includes a third RU independent of the MRU that is dedicated for the latency sensitive data, wherein the MRU is for non-latency sensitive data, latency sensitive data, or both.

17. The access point of claim 16, wherein the MRU and the third RU are different sizes.

18. A non-transitory computer readable storage medium configured to store instructions that, when executed by a processor included in a computing device, cause the computing device to perform operations comprising:
for an orthogonal frequency division multiple access (OFDMA) transmission, allocate an asymmetrical amount of frequency among a plurality of users to receive the OFDMA transmission, with a portion of the frequency being reserved for latency sensitive data.

19. The non-transitory computer readable storage medium of claim 18, wherein the frequency is allocated using a plurality of resource units (RUs) in a multiple RU (MRU), wherein at least two RUs of the plurality of RUs are allocated a different amount of frequency.

20. The non-transitory computer readable storage medium of claim 19, wherein a total amount of frequency available to allocate is at least 160 megahertz (MHz).
